(19) United States
(12) Patent Application Publication
(10) Pub. No.: US 2007/0261443 A1
(43) Pub. Date: Nov. 15, 2007

(54) Method and Device for Producing Flat Glass According to a Float Method

(75) Inventors: Carsten Schumacher, Horbach (DE); Armin Vogl, Jena (DE); Frank Klette, Jena (DE); Christian Kunert, Mainz-Kastel (DE); Bernhard Langner, Mainz (DE); Andreas Morstein, Jena (DE); Andreas Roters, Mainz (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHOTT AG, Mainz (DE)

(21) Appl. No.: 11/663,187

(22) PCT Filed: Aug. 26, 2005
(86) PCT No.: PCT/EP05/09213

§ 371 Date: Apr. 12, 2007

(30) Foreign Application Priority Data
Sep. 18, 2004 (DE) 10 2004 045 667.4

(51) Int. Cl. C03B 18/02

(52) U.S. Cl. 65/25.3; 65/169

(57) ABSTRACT

A method for reducing surface defects during production of a float glass with a transformation temperature Tg equal to or greater than 600° C. is provided which includes removing impurities from a surface of the glass strip in a float chamber by a molten metal flowing over the glass strip in the float bath. A device for carrying out the inventive method and a float glass whose transformation temperature is equal to or greater than 600° C. and which has a maximum of 3 surface defects (Top Speckd) whose size is greater than 35 μm per m² at the float chamber are also provided.

### BACKGROUND

The subject matter of the invention is a method and a device for producing flat glass with a transformation temperature of at least 600° C. according to the float method, in which molten glass in the form of an endless ribbon moves forwards in a float chamber on a bath of molten metal, the glass ribbon is cooled and solidified, and the solidified glass ribbon is lifted from the bath.

Due to the high temperatures that prevail in the float chamber of a float glass installation, it cannot be avoided that components are vaporized both from the molten glass and also from the molten metal (typically tin or tin alloys), which then precipitate at cooler positions of the float chamber. Due to baffles in the top part of the float chamber and due to suitable guidance of the process gas, it is largely prevented that such condensed components could be led from there to the glass ribbon and there form a deposit designated as “Top Specks.” The glass produced in this way has sufficient freedom from particles on its surface for many application purposes.

There are also applications, however, for which a glass, as it comes out of a float chamber, does not have a sufficient surface purity. This applies especially to refractory glasses, e.g., aluminosilicate glasses and borosilicate glasses, especially for display applications. For these cases, up to now the glass had to be cleaned after its production, generally for the first time during the finishing work according to the blank for the final format, which is complicated and generates high costs. Thus, it is known from U.S. Pat. No. 3,284,181 to etch the bottom side of the glass ribbon, which has been in contact with the tin bath, with an HF solution, in order to remove the glass layer carrying impurities of diffused tin ions.

This idea was taken up in JP 92 95 833 in order to remove small foreign particles from the surface of the glass ribbon. Outside of the use of hydrofluoric acid, an aqueous, acidic solution containing bivalent chromium ions can also be used. After this acid treatment, however, polishing of the glass ribbon is still necessary. Also according to JP 92 95 832, the surface of the glass ribbon is etched with an acidic solution containing chromium²⁺ ions. Another etching method is described in JP 1008 5684 A. Here, an ammonium halide is pyrolized on the greatly heated glass ribbon and the impurities on the surface of the glass ribbon volatize in the form of easily vaporizing halides.

All of these solutions for removing tin impurities from the glass surface take place as finishing steps. They are complicated and expensive, especially due to the necessary preparation and disposal of the etching solutions and reaction products.

### SUMMARY

Therefore, there is the objective of providing a method and a device for producing glass according to the float method, in which cleaning the surface of the glass ribbon still takes place in the float chamber, i.e., a glass ribbon that is largely free from impurities on the glass surface leaves the float chamber.

This objective is met by the method according to Claim 1 and also by the device according to Claim 4.

It has been found that a fluid deposited on the surface of the glass ribbon, whose composition largely corresponds to that of the float bath, takes up particles located on the glass bath. Under the statement that the composition of the fluid largely corresponds to that of the float bath, it is understood that impurities, e.g., metals, such as Cn, An, Ag, Pb, Bi, can be present in the fluid as long as they do not disrupt the operation of the float bath. As long as this fluid is not led into the float bath in large quantities, impurities of up to 10 wt. % in the fluid can be tolerated. For the sake of simplicity, this fluid is therefore noted as cleaning fluid below. The impurities are normally flushed away or taken up by the cleaning fluid. Preferably, float-bath material is used as the cleaning fluid, because then no special storage containers for the bath fluid are necessary, It is also possible, however, to use fresh, not yet used or cleaned float-bath material.

From U.S. Pat. No. 3,798,016 a method for modifying the surface of a glass ribbon located on a float bath is known, in which electrolytic lead ions are diffused into the surface of the glass ribbon connected as a cathode from a molten lead located on the glass ribbon at a high temperature and under application of an electric current. With this method, a heat reflective glass with gray-bronze color is generated. Due to the high temperature generated by the electric current and the low boiling point of lead, a portion of the lead vaporizes and condenses again behind the diffusion zone viewed in the advancing direction of the glass ribbon, which is colder at this location. This lead surface is separated again by molten lead, which is held stationary by means of a copper bar. The method is limited to the removal of lead surfaces and is obviously not suitable for removing top specks, because even 30 years after the publication of this document, top specks are still removed by means of the cited complicated etching method. A similar process is described in U.S. Pat. No. 3,607,175. From De-OS-1 569 619 it is known, to press the glass ribbon under the level of the float bath. In the smile of the metal of the float bath on the glass ribbon a parting wall is dipped in. Through this fluid seal, the maintenance and holding of the protective gas atmosphere in the float chamber is improved. FR-A-1 436 830 describes a process for cooling the glass upper surface in which the glass upper surface is cooled through contact with a cooling molten metal.

To avoid undesired cooling of the glass by the cleaning fluid, it should have the approximate temperature of the float bath at this position. In general, those are temperatures between 400 and 900° C. The cleaning fluid is enriched with particles held by the glass ribbon. It is therefore useful when the cleaning fluid located on the glass ribbon is regularly renewed as a function of the degree of contamination. It is especially advantageous when the cleaning fluid is fed continuously to the surface and is also naturally continuously removed from the glass ribbon after flowing over the glass ribbon, in that it can be suctioned away or it can flow into the float bath. Here, the cleaning fluid can be fed in the middle of the glass ribbon and removed at a side edge or also two side edges, but it is also possible to feed the cleaning fluid at one side edge, to allow it to run transverse over the glass ribbon, and to remove it again at the other side. The cleaning fluid is preferably fed with a suitable pump. The impurities are removed from the surface of the glass ribbon before the glass ribbon is lifted from the surface of the float bath, i.e., at a point, at which the glass ribbon has already largely solidified, i.e., become rigid enough that the cleaning fluid located on it can no longer cause any deformation.

If the cleaning fluid is fed to the glass ribbon at one position, at which it is already rigid, then one can press the side of the ribbon, at which the cleaning fluid is removed, somewhat downward in the direction of the float bath, e.g., with the help of a roller. Therefore, a trap is generated, which creates a controlled flow and simultaneously simplifies the removal of the cleaning fluid. Behind the roller, the glass ribbon then assumes its original shape again. When feeding the cleaning fluid in the middle of the ribbon, preferably both edges are pressed downward.

So that the cleaning fluid cannot extend too far along the glass ribbon, the spreading of the cleaning fluid is limited in and/or against the running direction of the glass ribbon.

This is achieved through a bar-shaped or swept back fluid limiter arranged cross-wise to a travel direction of the glass ribbon, in which suitable magnetic fields are generated, which are set so that a force is generated that presses the cleaning fluid away from the bar. Through a suitable arrangement of the magnetic fields, a lateral velocity can also be impressed onto the cleaning fluid, so that the cleaning fluid also obtains a flow in the direction of the glass edge. Such a bar is very reliable as a fluid barrier and is absolutely free from contact from the glass ribbon running under it. Various forms of magnetic fields can be used, e.g., static magnetic fields, whose magnitude and direction do not change and which operate according to the principle of an eddy-current brake, variable magnetic fields, such as those used, e.g., in a linear motor, or also high-frequency alternating fields with frequencies above 250 Hz.

Furthermore, a bar is suitable, which is equipped with gas passages in the direction towards the glass surface, wherein the gas passages can be bores or slots or can have the form of an open porous material. By passing gas through the openings, a levitating effect is generated; the bar hovers over the glass and cannot touch the surface. This has the advantage that the spacing of the bar from the glass ribbon can be kept very small without the risk of contact between the glass and bar. It is expensive, however, in that gas is continuously consumed for generating the levitating effect and in that the gas must be heated, so that the glass ribbon is not damaged. As gas, the inert gas in the float-gas installation can be used, which must be led into the bar merely by means of a corresponding fan. In this case, additional heating is necessary only to a small degree or not at all.

Furthermore, a bar with gas outlet openings can be provided, in order to blow the cleaning fluid away from the bar. The flow velocity for the gas should be greater than 1 m·s⁻¹, preferably greater than 5 m·s⁻¹, in particular greater than 10 m·s⁻¹, in order to press the cleaning fluid away from the bar. It should not be so great, however, that the cleaning fluid is blown away in the form of drops. This method, however, requires relatively large amounts of preheated gas. Also, recirculated float-bath atmosphere can be used as the gas. Such a bar can also be charged with air or oxygen instead of with inert gas. The oxygen reacts with the float-bath atmosphere and generates a preheated gas curtain. However, through careless process control, the generated flame curtain can damage the glass surface.

The bar must be arranged tightly over the glass surface, so that the cleaning fluid is held back by it. Transverse should be understood to be not only an angle of 90° to the advancing direction, but also so that the fluid limiter can be arranged at a different angle relative to the advancing direction. In general, the angle should not be greater than 45 degrees, because otherwise the cleaning device takes up a disproportionately large space in the float chamber and the fluid limiter is very long.

A small angle of approximately up to 15 degrees, however, can be advantageous, because it promotes the flow of the cleaning fluid on the glass ribbon in the direction of the edge. If an angle is used, it is useful to adapt the angle to the velocity of the glass ribbon, which can be realized through a few simple tests.

A second fluid limiter can be arranged behind the first fluid limiter viewed in the advancing direction of the glass ribbon, if there is the risk that the cleaning fluid will extend undesirably far in the ribbon advancing direction. A second fluid limiter is frequently unnecessary. In particular, it is not needed when the cleaning device is located in the spatial area of the lifting position, because the lifting angle, i.e., the resulting rising slope of the glass ribbon, limits the spread of the cleaning fluid.

The bar-shaped fluid limiter can comprise a wide variety of materials, wherein it is important that they cannot dissolve in the fluid or deform or melt at the high temperatures of about 600 to 1200° C. If necessary, the bar must be cooled. A material, which is wetted by the appropriate fluid, is suitable, because in this way the fluid is held back well. Suitable materials are, according to the temperature, tungsten, SiC, and typical ceramic materials, which can also be porous. Bars made from wettable materials can have a spacing of up to 6 mm, preferably of <1 to 3 mm, from the glass surface according to the viscosity of the fluid. They are as robust as possible and to be selected according to economic applicability.

Furthermore, a bar made from graphite is also suitable, optionally with a metal holder for simpler assembly. Because graphite cannot be wetted by the cleaning fluid, a graphite bar must have a spacing from the glass that is significantly below the tin equivalent thickness of approximately 5 to 6 mm. Grinding on the glass should be avoided but is tolerable for short periods. A graphite bar has the advantage that it can be produced economically and can be worked easily and exhibits non-critical behavior in terms of glass and fluid contact.

In contrast, a disadvantage is the low mechanical strength of the graphite and the necessity for a protective-gas atmosphere at high temperatures, which, however, is automatically present within the float installation.

The fluid limiter does not have to comprise a straight bar, tube, bar, or the like, but instead can also have a curved or sweptback construction. The curved and sweptback shape should always be arranged on the ribbon so that no “dead” spaces can be formed, in which the cleaning fluid can build up without being replaced by fresh cleaning fluid.

As already discussed farther above, the cleaning fluid should be regularly renewed or preferably fed to the glass ribbon continuously. The fed cleaning fluid can be removed according to generally typical methods. Thus, the cleaning fluid fed by means of a pump on one side of the glass ribbon can also be suctioned away with a pump on the other side. It is also possible to flush the cleaning fluid away from the glass ribbon electromagnetically with a device operating according to the principle of a linear motor. Because the cleaning fluid (largely) has the composition of the float bath, the fluid in the float bath can be flushed especially easily. If the mechanical condition of the glass ribbon permits, one side of the glass ribbon can be pressed deep into the float bath so that the top edge of the glass ribbon (including border) lies below the fluid level of the float bath. In this case, no suction device or the like is necessary, because the fed cleaning fluid can flow away from the surface of the glass ribbon and can flow into the bath without additional means. As a device for pressing the glass ribbon downward, a roller running in the edge area, especially at the border of the glass ribbon, can be used, but it is also possible to use a sliding block, because otherwise the border would become distorted. A gas-charged body, e.g., could also be used, which presses the glass ribbon downward due to the levitating effect. Obviously, it is also possible to press the edge of the glass downward on both sides.

The amount of cleaning fluid fed to the glass ribbon depends on the number of particles located on the glass ribbon (i.e., on the desired cleaning effect) and can vary within a wide range, wherein the width of the glass ribbon to be cleaned is also to be taken into account. The expansion of the cleaning fluid on the glass ribbon in the longitudinal direction preferably equals 1 to 100 cm, especially 1 to 10 cm. The layer thickness of the cleaning fluid on the glass ribbon should equal, for example, 1 to 30 mm, preferably 3 to 6 mm. It is, however, dependent on the surface tension and weight of the cleaning fluid at the corresponding temperature. Care should be taken that the glass ribbon does not deform too greatly due to the weight of the cleaning fluid, because this can cause undesired tensile forces, which can deform the still-soft portion of the glass ribbon lying farther forwards.

The cleaning fluid can be guided very favorably between two fluid limiters. This is offered especially when the layer thickness of the cleaning fluid is to be kept high over the glass ribbon. Because the fluid would expand far onto the glass ribbon with a large layer thickness without a limiting device, through multi-sided limiting the consumption of cleaning fluid and thus the energy consumption for the pumps can be reduced. In principle, one can manage with one limiter but, if necessary, several limiters can also be arranged one behind the other, in order to reliably hold back fluid possibly not caught by one limiter. For two limiters arranged one behind the other, the spacing between both can be arbitrary, in principle, but obviously the spatial relationships in the float chamber have to be taken into account. Therefore, the spacing of the limiter should lie preferably within the specified longitudinal expansion of the cleaning fluid. The two fluid limiters can operate according to the same working principle. To rule out effects of the fluid limiters on each other, however, fluid limiters operating according to different principles can also be used, e.g., a limiter, in which a magnetic field is generated and a limiter, from which a gas flow emerges.

The subject matter of the invention is furthermore an alkali-free float glass with a transformation temperature Tg of at least 600° C. at a viscosity η of 10¹³ dPas with an exceptionally high surface quality, wherein float glass is understood to be the float glass as it comes out of the float installation, i.e., without chemical or mechanical finishing work, such as etching, grinding, polishing, and the like.

The float glass has a maximum of three surface defects (top specks) with a size of more than 50 μm per m². An alkali-free float glass with a transformation temperature Tg of at least 600° C. at a viscosity η of 10¹³ dPas and a thickness of less than 1.5 mm is preferred. It is especially suitable for the production of TFT (thin film transistor) monitors. Because thermal processes are applied during the course of the monitor production, it is advantageous to use glasses with a higher transformation temperature for the purpose of higher glass stability. Therefore, a glass with a transformation temperature Tg of 650 to 780° C., especially 700 to 730° C. is preferred. Such glasses are preferably alkali-free borosilicate glasses or aluminosilicate glasses for TFT applications. One such glass is described, for example, in US-2002/01831888 A1. Furthermore, it is advantageous for the glass to be as thin as possible for the purpose of saving weight. Therefore, glasses with a thickness of 0.2 to 0.9 mm are preferred. The number of surface defects (top specks) and their size is important for the quality of the glass, especially for a TFT monitor application. Therefore, it is preferred when the surface defects are not greater than 35 μm, in particular, not greater than 20 μm. Because the top specks are typically round, the measure of 50 or 35 or 20 μm relates to a round-circular defect with such a diameter. For oval or similarly shaped surface defects, this measure relates to the greatest extent of the defect.

### BRIEF DESCRIPTION OF THE DRAWINGS

The invention is explained in more detail in the drawing. Shown are

FIG. 1 a schematized top view of the glass ribbon with cleaning device with side feeding of the cleaning fluid,

FIG. 2 a cross sectional view through FIG. 1 viewed from the border,

FIG. 3 a schematized top view of the glass ribbon, in which the cleaning fluid is fed at the middle,

FIG. 4 a cross sectional view through FIG. 3, viewed from the border.

### DETAILED DESCRIPTION OF THE PREFERRED EMBODIMENTS

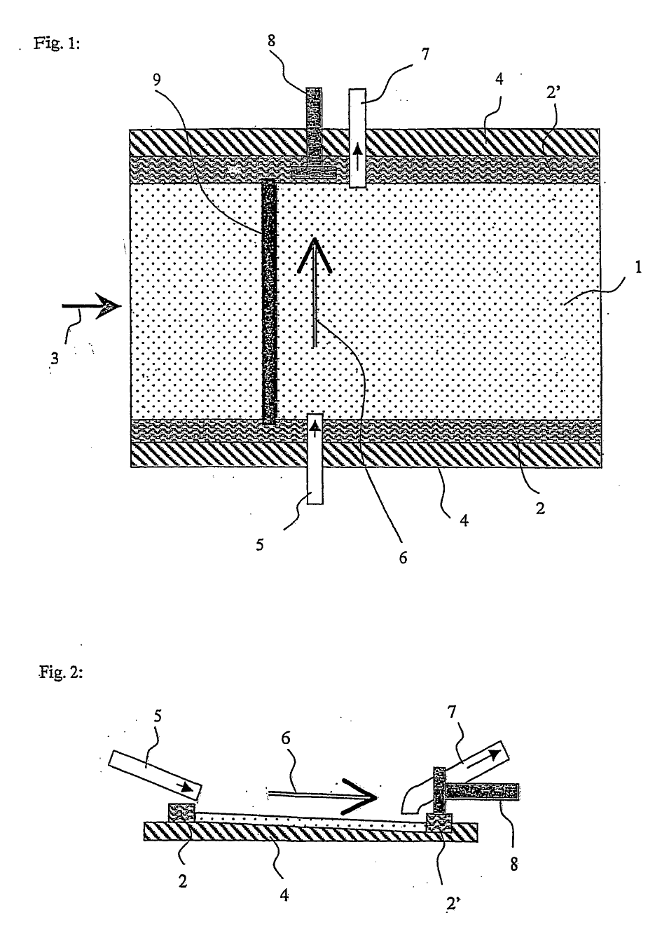

In FIGS. 1 and 2, a section from a float installation is shown schematically in top view and cross section, respectively. The glass ribbon 1, which carries borders 2 and 2′ on both edges from the preceding drawing process, moves in the direction of the arrow 3 over the float bath 4 composed of tin or a tin alloy. Cleaning fluid, in this case, molten tin, is fed through the tube 5 onto the glass ribbon 1 and flows in the direction of the arrow 6 to the opposite side of the glass ribbon. Here, the cleaning fluid is suctioned through the suction tube 7 and removed from the glass. The flow of cleaning fluid in the direction towards the suction tube 7 is supported, in that a pressure is exerted onto the border 2′ with the help of the pressure roller 8, so that the glass ribbon 1 receives a downward slope in the direction towards the suction tube 7. So that the cleaning fluid does not spread too far onto the glass ribbon 1, a fluid barrier 9 is provided. The fluid barrier 9 is comprised of a bar, which is arranged above the glass ribbon and which is made, e.g., from tungsten that is held over the borders 2 and 2′ at a spacing of <1 mm. Due to its wet-ability with the cleaning fluid, it reliably holds back the metallic cleaning fluid. The pressure roller 8 can be comprised of metal, but preferably is graphite. It is usually not driven and is used merely for exerting a pressure onto the side edge of the glass ribbon. Because the cleaning device is installed at a position in the float chamber, at which the glass ribbon can be deformed barely plastically, the glass is also not deformed permanently by the pressure roller 8.

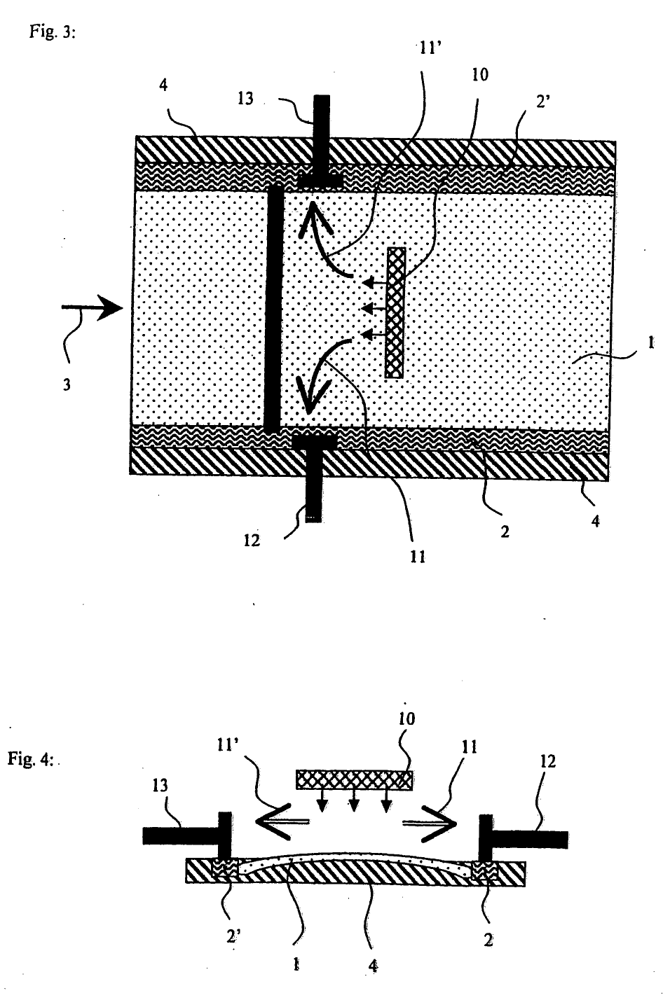

FIGS. 3 and 4 show a different embodiment of the cleaning device. Here, the cleaning fluid is fed onto the glass ribbon at the middle through a feeding device 10, which has many small nozzles similar to a drip installation or also a wide-slot nozzle, and flows, as shown by the arrows, towards the two edges of the glass ribbon 1. This flow is supported in that a slightly convex surface of the glass ribbon is generated, which creates a downward slope for the cleaning fluid in the direction of the side edges, with the help of pressure rollers 12 and 13. In the shown representation, the side edges of the glass ribbon 1, the borders 2 and 2′, are pressed so deep into the float bath 4 that their top edge lies at the same height or below the bath level of the float bath 4. Therefore, the cleaning fluid, which is fed by the feeding device 10 and which has the same composition as the float bath 4, can run easily in the float bath without additional auxiliary means. The curvature of the glass ribbon shown in FIG. 4 is not shown true to scale. In practice, the border is also only slightly thicker than the glass ribbon and consequently the side edges (borders) must be pressed downward accordingly, so that they end below the bath level of the float bath 4. A fluid limiter 9 also provides that the cleaning fluid cannot spread against the advancing direction of the ribbon.

With the invention, it has become possible for the first time to generate a glass, which, already in the float chamber, has such a quality that it can also be used without greater cleaning steps even in demanding fields of use.

1. Method for producing flat glass with a transformation temperature of at least 600° C. according to a float method, in which molten glass in the form of an endless ribbon moves forward on a bath made from molten metal, the glass ribbon is cooled and solidified, and the solidified glass ribbon is lifted from the bath, characterized in that
before the already largely solidified glass ribbon is lifted, the surface of the glass ribbon is cleaned in its essential width with a cleaning fluid, whose composition largely corresponds to that of the bath.

2. Method according to claim 1, characterized in that the cleaning fluid is regularly renewed.

3. Method according to claim 1 or 2, characterized in that the cleaning fluid is continuously fed to the surface of the glass ribbon.

4. Method according to one or more of claims 1 to 3, characterized in that the spread of the cleaning fluid in and/or against the advancing direction of the glass ribbon is limited.

5. Method according to claim 4, characterized in that the limiting is performed by at least one fluid limiter arranged transverse to the advancing direction directly over the glass ribbon.

6. Method according to claim 5, characterized in that the fluid limiter is arranged at an angle of 0 to 45 degrees, especially 0 to 15 degrees, to an advancing direction of the glass ribbon.

7. Method according to claim 6, characterized in that a fluid limiter made from a material that can be wet by the fluid is used.

8. Method according to claim 5 or 6, characterized in that a bar is used, in which magnetic fields are generated, as the fluid limiter, through which cleaning fluid is pressed away from the bar.

9. Device for producing float glass with a transformation temperature of at least 600° C. in ribbon form on a float bath made from molten metal located in a float chamber, means for feeding fluid glass on one side of the float chamber, means for cooling the glass, and means for removing the solidified glass ribbon on the other side of the float chamber characterized by
a feeding device (5, 10) for a cleaning fluid, whose composition largely corresponds to a composition of the float bath, onto the largely solidified glass ribbon (1) located on the float bath and a discharge device (7) for removing the consumed cleaning fluid from the glass ribbon (1) located on the float bath.

10. Device according to claim 9, characterized in that a device, e.g., roller (8, 12, 13) is arranged in an area of the discharge device (7), with which an edge of the glass ribbon can be pressed downward for improving flow control.

11. Device according to claim 9 or 10, characterized in that in an area of the feeding and discharge device of the cleaning fluid, there is a bar-shaped fluid limiter (9) extending over an entire width of the glass ribbon at a small spacing from the glass ribbon for preventing an excessively large expansion of the cleaning fluid.

12. Device according to claim 11, characterized in that a spacing between the fluid limiter (9) and glass ribbon (1) equals 1 to 5 mm.

13. Device according to claim 11 or 12, characterized in that the fluid limiter (9) is comprised of a material that can be wet by the cleaning fluid.

14. Device according to claim 11 or 12, characterized in that magnetic fields can be generated in the fluid limiter (9).

15. Device according to claim 11 or 12, characterized in that the fluid limiter (9) is comprised of a bar made from open porous material or is provided with bores, so that a gas cushion can be generated between the glass ribbon and fluid limiter.

16. Alkali-free flat glass produced according to the float method with a transformation temperature Tg of at least 600° C. at a viscosity η of 10¹³ dPas with a maximum of three surface defects (Top Specks) with a size of more than 50 μm per m² at an outlet from the float chamber.

17. Flat glass according to claim 16, characterized in that it has a maximum of three surface defects with a size of more than 35 μm per m².

18. Flat glass according to claim 16, characterized in that it has a maximum of three surface defects with a size of more than 20 μm per m².

19. Flat glass according to at least one of claims 16 to 18, characterized in that it has a maximum of 2 surface defects per m².

20. Flat glass according to at least one of claims 16 to 19, characterized in that it has a transformation temperature Tg of 650 to 780° C., especially 700 to 730°, at a viscosity η of 10¹³ dPas.

21. Flat glass according to at least one of claims 16-20, characterized in that it has a thickness of less than 1.5 mm, especially 0.2 to 0.9 mm.
